(19) United States
(12) Patent Application Publication
(10) Pub. No.: US 2004/0032380 A1
(43) Pub. Date: Feb. 19, 2004

(54) Device for and method of driving luminescent display panel

(75) Inventor: Katuhiro Kanauchi, Yonezawa-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: TOHOKU PIONEER CORPORATION, Tendo-shi (JP)

(21) Appl. No.: 10/633,543

(22) Filed: Aug. 5, 2003

(30) Foreign Application Priority Data
Aug. 7, 2002 (JP) 2002-230072

(51) Int. Cl. G09G 3/28

(52) U.S. Cl. 345/63; 345/72; 345/65

(57) ABSTRACT

Provided is an active matrix type EL display device, which is constructed in the way a reverse bias voltage is effectively applied to the EL element without decreasing the light-up time period percentage. The EL element 14 constituting one pixel 10 is light-up driven by a control TFT 11 and a drive TFT 12. To a cathode line C1 having commonly connected thereto the cathode sides of the EL elements 14 arrayed correspondingly to a scanning line A1, there is applied a forward-directional voltage that is determined using the voltage level of a common anode 16 as a reference, or a reverse bias voltage. In a case where a reverse bias voltage has been applied to the cathode line C1, a diode 15 becomes electrically conductive through bypassing the drive TFT 12. By this, it is possible to effectively apply a reverse bias voltage to the EL element. For example, in case where making concurrent use of a simultaneous erasure scan method (SES) in the time division gradation expression means, it is also possible to avoid the problem that the light-up time period percentage of the EL element is decreased.

### BACKGROUND OF THE INVENTION

1. Field of the Invention

The present invention relates to a device for driving a display panel that performs active driving of a luminescent element constituting a pixel by, for example, a TFT (Thin Film Transistor) and, more particularly, to a device for and a method of driving a display panel, which enable effectively applying a reverse bias voltage with respect to the luminescent element.

2. Description of the Related Art

Development of a display that uses a display panel constructed of luminescent elements arranged in the form of a matrix has gone on being widely made. As a luminescent element that is used in such display panel, attention has been drawn toward an organic EL (electroluminescence) element wherein, for example, organic material is used in the luminescent layer. One of the reasons therefor is that, by using in a luminescent layer of the EL element an organic compound from which good luminescent property can be expected, the increase in the efficiency and that in the service life which can resist the practical use of the resulting EL element has made their progress.

As the display panel that uses such an organic EL element, two display panels have hither to been proposed, one being a simple matrix type display panel wherein the EL elements are simply arranged in the form of a matrix and the other being an active matrix type display panel wherein to each of the EL elements arranged in the matrix form there has been added an active element consisting of, for example, a TFT (Thin Film Transistor). Compared with the former simple matrix type display element, the latter active matrix type display panel enables realizing low power consumption. In addition, it has the property of, for example, its being less in terms of the crosstalk between the pixels. It therefore is suitable especially for a display with a high degree of fineness that constitutes a large screen.

FIG. 1 illustrates an example of a circuit construction that corresponds to one pixel 10 in a conventional active matrix type display panel. In FIG. 1, a gate G of a control TFT 11 is connected to a scanning line (the scanning line A1) and a source S is connected to a data line (the data line B1). Also, a drain D of the control TFT 11 is connected to a gate G of a drive TFT 12 and is also connected to one terminal of a capacitor 13 for holding electric charge.

A drain D of the drive TFT 12 is connected to the other terminal of the capacitor 13 and is also connected to a common anode 16 formed within the panel. Also, a source S of the drive TFT 12 is connected to an anode of an organic EL element 14 and a cathode of the organic EL element 14 is connected to a common cathode 17 that constructs, for example, a reference potential point (the earth) formed within the panel.

FIG. 2 typically illustrates a state wherein the circuit construction for each pixel 10 illustrated in FIG. 1 is arrayed in a display panel 20. In each of the intersections of the respective scanning lines A1 to An and the respective data lines B1 to Bm, there is formed the pixel 10 having the circuit construction illustrated in FIG. 1. And, in the above-described construction, the respective drain D of the drive TFTs 12 is connected to the common anode 16 illustrated in FIG. 2 and the respective cathode of the EL elements 14 are respectively connected to the common cathode 17 illustrated in FIG. 2. And, when, in this circuit, luminescence control is performed, a positive power source terminal of a voltage source E1 is connected to the common anode 16 formed in the display panel 20 via a switch 18, and a negative power source terminal of the voltage source E1 is connected to the common cathode 17.

When, in this state, an “on” voltage is supplied to the gate G of the control TFT 11 of FIG. 1 via the scanning line, the TFT 11 causes an electric current, corresponding to the voltage supplied from the data line to the source S, to flow from the source S to the drain D. Accordingly, during a time period in which the gate G of the TFT 11 has the voltage made “on”, the capacitor 13 is electrically charged, and the voltage is supplied to the gate G of the TFT 12. Thereby, the TFT 12 causes the electric current based on the gate voltage and the drain voltage to flow from the source S into the common cathode 17 through the intermediary of the EL element 14 to thereby cause luminescence of the EL element 14.

Also, when the gate G of the TFT 11 has the voltage made “off”, the TFT 11 becomes a so-called state of “cut-off”, with the result that the drain D of the TFT 11 becomes an open state. However, the drive TFT 12 has the voltage of its gate G held by the charge accumulated in the capacitor 13, thereby the drive current is maintained until the next scan is performed, thereby the luminescence of the EL element 14 is also maintained. Incidentally, since in the drive TFT 12 there exists the gate input capacitance, even if the capacitor 13 is not provided in particular, it is possible to cause the performance of the same operation as stated before.

By the way, it is known that the organic EL element, saying from the electrical point of view, as stated above, has a luminescent element having a diode characteristic and an electrostatic capacitance (parasitic capacitance) connected in parallel with respect thereto, whereby the organic EL element luminesces with a luminance that is almost proportionate to the magnitude of forward current as applied to the diode-characteristic luminescent element. It is also empirically known that, in the above-described EL element, by sequentially applying a voltage of backward direction having no relevancy to the luminescence (backward bias voltage), crosstalk luminescence can be more decreased and, at the same time, the service life of the EL element can be extended.

In view thereof, in, for example, Japanese Patent Application Laid-Open No. 2001-117534, it is disclosed that a reverse bias voltage is applied between the common anode 16 and the common cathode 17. Namely, a voltage source E2 illustrated in FIG. 2 is the one that is used when applying the above-described reverse bias voltage, and, when a reverse bias voltage is applied, the switch 18 is switched to the voltage source E2 side. As a result of this, to the common cathode 17 a positive power source terminal of the voltage source E2 is connected, and to the common anode 16 there is connected a negative power source terminal of the voltage source E2. Accordingly, with respect to the EL element 14 illustrated in FIG. 1, a reverse bias voltage is applied via the drain D and source S of the drive TFT 12.

According to the conventional drive device for a display panel illustrated in FIGS. 1 and 2, it is constructed in the way the EL element 14 is connected between the common anode 16 and the common cathode 17 via the drive TFT 12. For this reason, in case where applying a reverse bias voltage is applied to the EL element 14, a period of time in which all of the EL elements are temporarily turned off must be set. Therefore, in the example disclosed in the above-described Japanese Patent Application Laid-Open No. 2001-117534, in case where utilizing a time division gradation expression method, the following control is performed. That is, in the lighting-up (turning-on) time period for the EL element in a first sub-field (SF1) that starts from the terminating point in time of the addressing period of time at which a scanning signal has finished being supplied to every one of the scanning lines, a period of time (Tb) in which a reverse voltage should simultaneously be applied to every one of the EL elements is set.

In this way, besides setting the turning-on and turning-off time periods for the EL element that are provided for performing the gradation expression, the turning-off time period for applying a reverse voltage with respect to the EL element is set. This inevitably leads to decreasing the luminous duty ratio, i.e. the lighting-up time period percentage, of the EL element. As a result, the substantial value of luminance of the EL element decreases and, for making compensation therefor, the necessity arises of raising the drive current at the time of lighting up the EL element. This results in raising the problem that the load of the power source circuit is increased.

In addition, according to the above-described application operation of a reverse voltage, since with respect to the respective circuits, each including the EL element and the capacitor serving to perform the voltage holding function, corresponding to all the pixels, the switching operations for a positive voltage and a reverse bias voltage are simultaneously performed, it is inevitable that the load current greatly increases at the instantaneous switching point in time. For that reason, in the power source circuit as well, it becomes necessary that measures with respect to the large load current that instantaneously flows be taken.

Furthermore, according to the example disclosed in the above-described Japanese Patent Application Laid-Open No. 2001-117534, when applying a reverse bias voltage, the problem remains that a reverse bias voltage cannot but be applied to the EL element 14 via the impedance between the drain D and source S of the drive TFT 12. In this case, the drive TFT 12 is set so that constant-current driving may be performed for guaranteeing the stable driving operation of the EL element. Accordingly, the impedance between the drain D and the source S is being kept high.

For this reason, even if a reverse bias voltage is applied between the common anode and the common cathode, due to the existence of the drive TFT 12 exhibiting high impedance, it is impossible to promptly escape the charge accumulated in the parasitic capacitance of the EL element when applying a positive bias voltage. Resultantly, there remains the problem that a reverse bias voltage cannot effectively be applied to the EL element.

### SUMMARY OF THE INVENTION

The present invention has been made in view of the above-described technical points in problem and has a main object to provide a device for and a method of driving a luminescent display panel, which enables effectively applying a reverse bias voltage to the EL element without decreasing the light-up time period percentage. It is another object of the present invention to provide a device for and a method of driving a luminescent display panel, which enables diffusing, from the viewpoint of time, the load current that concentratedly occurs when having applied a reverse bias voltage.

To attain the above object, according to the present invention, there is provided, as described in claim 1, a device for driving a luminescent display panel, the device being the one for driving an active matrix type display panel that is equipped with a plurality of luminescent elements that are arrayed at the positions of intersection between a plurality of data lines and a plurality of scanning lines and at least each one of that is luminescence controlled via a light-up drive transistor, the device having a construction wherein a light-up mode in which a forward-directional voltage is applied to the luminescent element via the light-up drive transistor and a reverse bias voltage applying mode in which a reverse bias voltage is applied to the luminescent element via the light-up drive transistor can be selectively determined, and wherein, in case where the reverse bias voltage applying mode is selected, there operates reverse bias voltage applying means that applies a reverse bias voltage to the luminescent element while bypassing the light-up drive transistor.

In this case, in a preferred one form of the device, as described in claim 3, electrode lines having commonly connected thereto the plurality of luminescent elements arrayed correspondingly to the scanning lines are formed in the way of their being electrically separated every scanning line, whereby the device has a construction wherein, by applying a prescribed voltage level to the respective electrode lines, the reverse bias voltage applying mode is selected.

On the other hand, to attain the other above object, according to the present invention, as described in claim 7, there is provided a method of driving a luminescent display panel, the method being the one of driving an active matrix type display panel that is equipped with a plurality of luminescent elements that are arrayed at the positions of intersection between a plurality of data lines and a plurality of scanning lines and at least each one of that is luminescence controlled via a light-up drive transistor, which comprises a luminescent element light-up step of applying a forward-directional voltage to the luminescent element via the light-up drive transistor and a reverse bias voltage applying step of applying a reverse bias voltage to the luminescent element via the light-up drive transistor, whereby, in case where the reverse bias voltage applying step is executed, there operates reverse bias voltage applying means that applies a reverse bias voltage to the luminescent element while bypassing the light-up drive transistor.

### BRIEF DESCRIPTION OF THE DRAWINGS

FIG. 1 is a line connection diagram illustrating an example of a circuit construction that corresponds to one pixel of a conventional active matrix type display panel;

FIG. 2 is a plan view typically illustrating a state where the circuit constructions of the respective pixels each illustrated in FIG. 1 are arrayed in a display panel;

FIG. 3 is a block diagram illustrating a first embodiment of a driving device according to the present invention;

FIG. 4 is a line connection diagram illustrating the circuit construction of one of the pixels formed in the display panel illustrated in FIG. 3;

FIG. 5 is a line connection diagram illustrating a detailed construction in case where performing luminescence driving of each pixel;

FIG. 6 is a timing chart illustrating an example wherein gradation control is performed by dividing a unit frame period into a plurality of sub-field periods;

FIG. 7 is a timing chart illustrating the operation performed in a line-sequential display method that is adopted in case where performing the gradation expression illustrated in FIG. 6;

FIG. 8 is a line connection diagram illustrating a second embodiment in which there is adopted for control of the gradation an analog control method;

FIG. 9 is a timing chart illustrating an example of a control method wherein a reverse bias voltage is supplied in the embodiment illustrated in FIG. 8;

FIG. 10 is a line connection diagram illustrating a third embodiment having omitted therefrom the first gate driver in FIG. 8;

FIG. 11 is a block diagram illustrating a fourth embodiment of the driving device according to the present invention;

FIG. 12 is a line connection diagram illustrating the circuit construction of one of the pixels formed in the display panel illustrated in FIG. 11;

FIG. 13 is a line connection diagram illustrating a modification of the pixel construction example illustrated in FIG. 4;

FIG. 14 is a line connection diagram illustrating a modification of the pixel construction example illustrated in FIG. 4;

FIG. 15 is a line connection diagram illustrating another pixel construction example to which the present invention is applied; and

FIG. 16 is a line connection diagram illustrating still another pixel construction example to which the present invention is applied.

### DESCRIPTION OF THE PREFERRED EMBODIMENTS

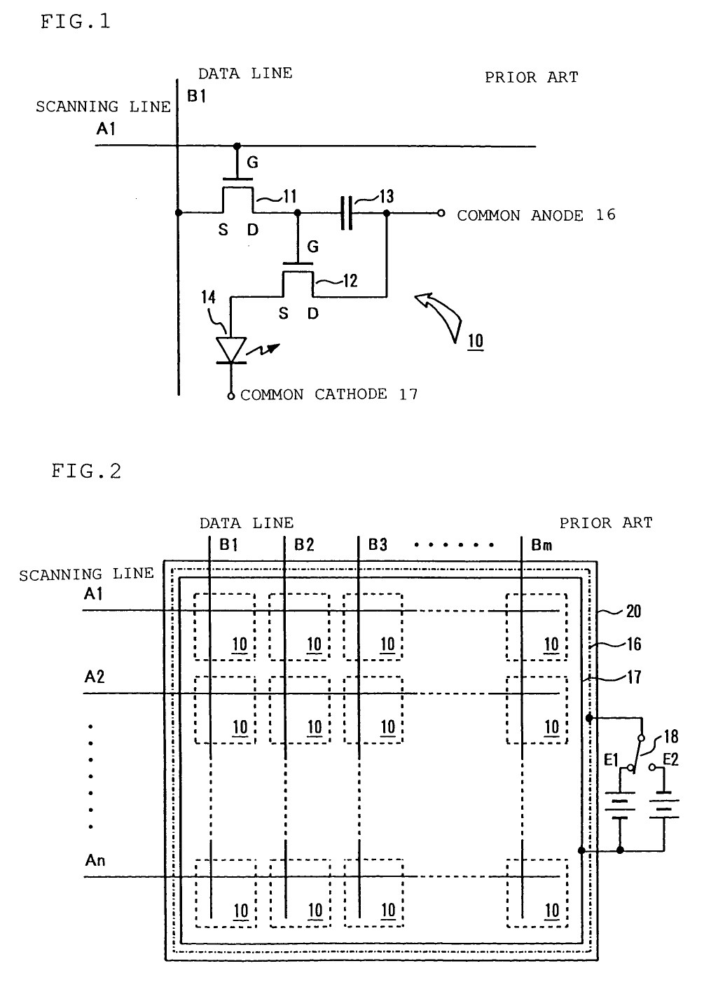

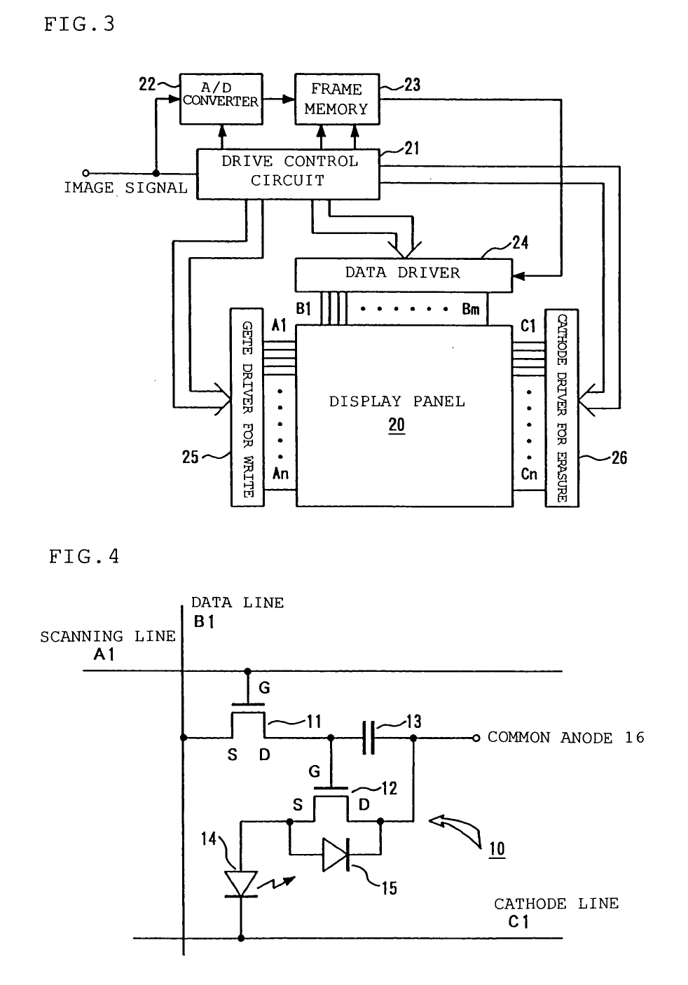

Hereinafter, a device for driving a luminescent display panel according to the present invention will be explained according to the embodiments illustrated in the drawings. It is to be noted that, in the explanation that will be given below, the portions that correspond to the respective portions that have been explained in connection with FIGS. 1 and 2 are denoted by like reference numerals. First, FIG. 3 illustrates, by a block diagram, a first embodiment of the driving device according to the present invention. In FIG. 3, an analog image signal that has been input is supplied to a drive control circuit 21 and an analog/digital (A/D) converter 22. According to a horizontal synchronizing signal and vertical synchronizing signal in the analog image signal, the drive control circuit 21 generates a clock signal with respect to the A/D converter 22 and generates a write signal and read-out signal with respect to a frame memory 23.

The A/D converter 22, according to a clock signal supplied from the drive control circuit 21, performs sampling of the analog image signal that has been input and converts this sampled image signal into pixel data corresponding to every one pixel and acts to supply it to the frame memory 23. The frame memory 23 operates, upon receipt of a write signal from the drive control circuit 21, to sequentially write each pixel data supplied from the A/D converter 22 into the frame memory 23.

When, through the performance of the write operation, the data corresponding to one screen (m rows and n columns) of the display panel has finished being written, the memory 23 operates, upon the read-out signal supplied from the drive control circuit 21, to sequentially supply to a data driver 24 the drive pixel data that has been read out from the 1st row toward the mth row every row data.

On the other hand, simultaneously with that, a timing signal is sent out to a writing gate driver 25 from the drive control circuit 21, and, according thereto, a gate driver 25, as later described, sequentially sends out a gate-“on” voltage signal to each scanning line. Accordingly, the drive pixel data for every one row that has been read out from the memory 23 in the above-described way is subjected to addressing every row through the scan performance of the gate driver 25. Also, this embodiment is constructed in the way a control signal is sent out to an erasing cathode driver 26 from the drive control circuit 21.

The erasing cathode driver 26, upon receipt of a control signal from the drive control circuit 21, as later described, selectively applies a prescribed voltage level to each electrode line (in this embodiment called “the cathode lines C1 to Cn”) that is arrayed in the way of their being electrically separated every scanning line. It thereby operates to supply a forward-directional, or reverse bias voltage to the EL element.

FIG. 4 illustrates the circuit construction of one of the respective pixels 10 disposed in the form of a matrix in the display panel 20 illustrated in FIG. 3. Incidentally, in this FIG. 4, the portions corresponding to those already explained in connection with FIG. 1 are denoted by the same reference symbols and those corresponding portions have their detailed explanation omitted. In this circuit construction illustrated in FIG. 4, between a source S and a drain D of a light-up drive TFT 12 there is connected a diode 15 in the way it bypasses them. Namely, regarding the diode 15, an anode electrode (anode) thereof is connected to an anode of the EL element 14 and a cathode electrode (cathode) thereof is connected to a common anode 16. Accordingly, the diode 15 is connected, in parallel, to between the source S and the drain D of the drive TFT 12 so that the direction of its voltage signal's acting may become opposite to the forward direction of the EL element 14 having the property as a diode.

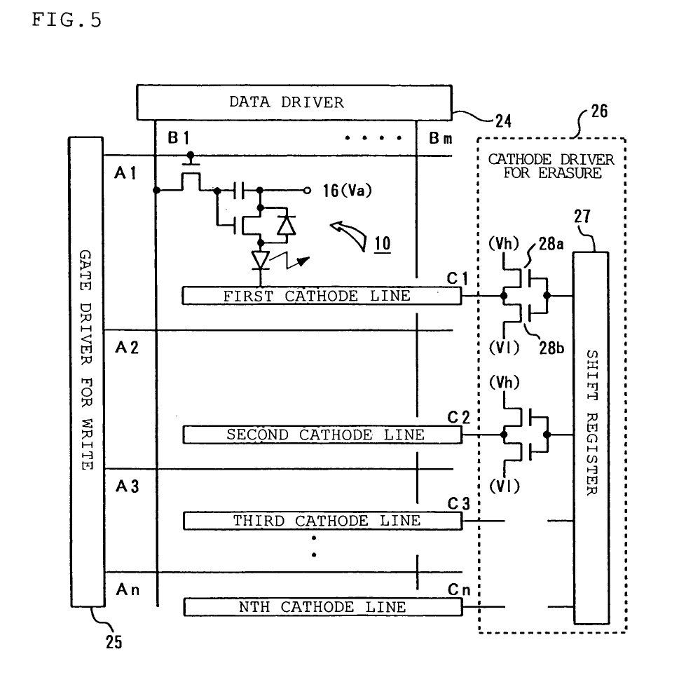

On the other hand, in the circuit construction illustrated in FIG. 4, the cathode electrode (cathode) of the EL element 14 is connected to a common electrode line (cathode line C1) formed correspondingly to the scanning line A1. And, as later described, by the erasing cathode driver 26 illustrated in FIG. 3, it is constructed so that a prescribed voltage level (the forward-directional voltage or reverse bias voltage as viewed with respect to the EL element) may be applied to the cathode line. Namely, as illustrated in FIG. 5, the pixel is constructed in the way the cathode lines C1 to Cn are formed correspondingly to the scanning lines A1 to An; and, as described above, the cathodes of the respective EL elements 14 disposed correspondingly to the respective scanning lines A1 to An are commonly connected to the respective cathode lines C1 to Cn.

And, as illustrated in FIG. 5, it is arranged that, to the respective cathode lines C1 to Cn, a prescribed voltage level signal can be applied each. Namely, assuming that here “Va” represents the voltage level applied to the common anode 16, “Vh” or “Vl” is selectively applied to each of the cathode lines C1 to Cn. The level difference of “Va” as viewed with respect to the level “Vl”, i.e. the Va-Vl is set so that, in the EL element 14, it may become a forward-directional voltage (e.g. 10 V or so). Accordingly, in case where “Vl” has selectively been set with respect to the respective cathode lines C1 to Cn, the EL element 14 that constitutes each pixel 10 is brought to a state of luminescence.

Also, the level difference of “Va” as viewed with respect to the level “Vh”, i.e. the Va-Vh is set so that, in the EL element 14, it may become a reverse bias voltage (e.g. −8 V or so). Accordingly, in case where “Vh” has selectively been set with respect to the respective cathode lines C1 to Cn, the EL element 14 that constitutes each pixel 10 is brought to a state of non-luminescence (erasure). At this time, the diode 15 illustrated in FIG. 4 is brought to a state of electrical conduction by the reverse bias voltage.

The applying operation of applying “Vh” or “Vl” to the respective cathode lines C1 to Cn is controlled, as illustrated in FIG. 5, by a shift register 27 disposed in the erasing cathode driver 26. Namely, to the shift register 27, there is supplied from the drive control circuit 21 illustrated in FIG. 3 a shift timing signal and, in addition, there is also supplied a data signal corresponding to the 1 sub-field period. In the shift register 27, the data signal is sequentially shifted up by the timing signal and is stored in the register thereof. By the data signal that is stored in each register at that time, the FET (Field Effect Transistor) or TFT 28a, 28b is selectively turned on, with the result that the voltage level of either “Vh” or “Vl” is applied to a relevant one of the respective cathode lines C1 to Cn.

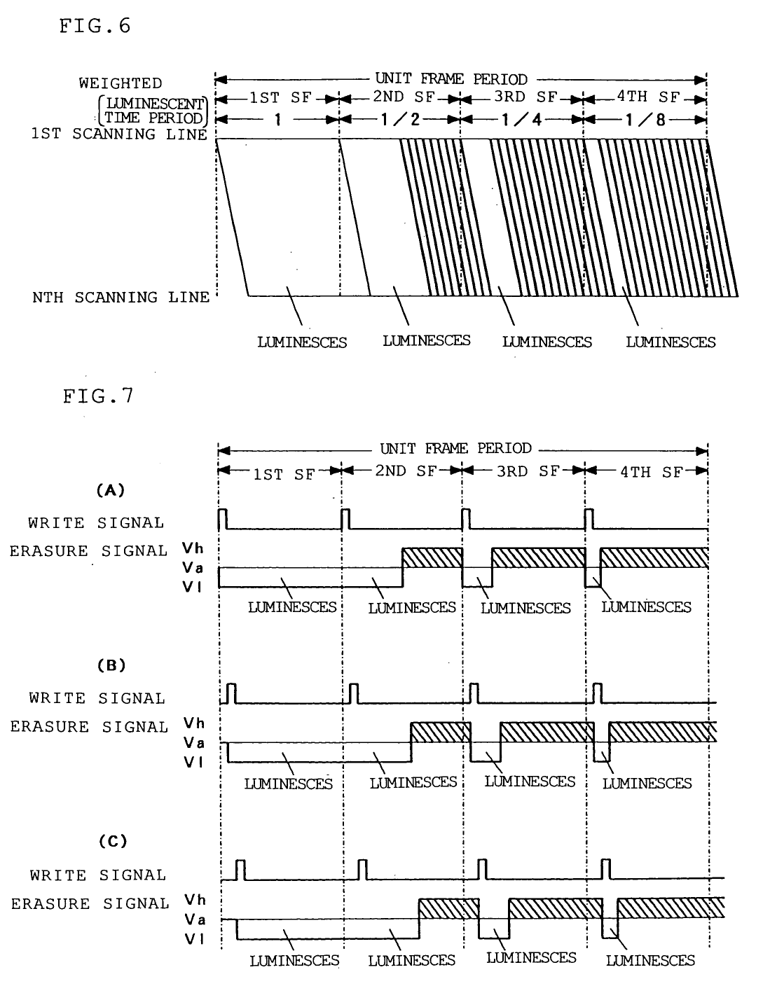

On the other hand, in this embodiment, it is arranged that the drive control circuit 21 illustrated in FIG. 3 has a construction in the way the unit frame period of an input image signal is divided into a plurality of sub-field periods; and, within the respective sub-field periods, a drive signal that performs light-up control of the EL element 14 is supplied to the data driver 24, the writing gate driver 25, and the erasing gate driver 26. The operation of dividing this unit frame period into a plurality of sub-field periods is performed for performing gradation expression (weighted time gradation). Namely, as illustrated in FIG. 6 for brevity of the explanation, the relative ratio of the luminance in one sub-field period to that in another one, i.e. the ratio of the luminescent period of the EL element in the respective sub-field periods is set in the way of being 1, ½, ¼, and ⅛ every sub-field period. And, by selecting the sub-field periods and combining the selected ones with one another, it is possible to realize multi-gradation expression.

Incidentally, in the example illustrated in FIG. 6, for brevity of the illustration, the unit frame period is divided into the first to the fourth sub-field period (the 1st SF to the 4th SF). The greater the number of divided sub-field periods is, the more multiple the gradation that can be realized becomes. However, the more increased the number of divided sub-field periods is, the more increased the driving frequency must be. In view of this, practically, it has been proposed that the unit frame period be divided into, for example, 8 sub-field periods to thereby realize a gradation of 256 levels.

The drive control circuit 21 illustrated in FIG. 3 operates to control the luminescent time period for each pixel, every sub-field period, according to the luminance gradation that has been set. Namely, from the drive control circuit 21, according to the timing that occurs every sub-field period, an addressing (write) signal is supplied to a shift register not illustrated in the writing gate driver 25. Also, in synchronism with this, from the drive control circuit 21, with respect to the data driver 24, luminescence drive data corresponding to one sub-field period is sequentially supplied correspondingly to the scan performed every scanning line. Further, from the drive control circuit 21, with respect to the erasing cathode driver 26, there is supplied the data that occurs according to the luminescent pattern based on the set luminance gradation and determined every sub-field period. Therefore, with respect to the respective cathode lines C1 to Cn, there is supplied the above-described voltage level (either “Vl” or “Vh”) that has been determined every sub-field period.

In the above-described luminescence driving operation that occurs every sub-field period, there is adopted the so-called line-sequential display method that is sequentially executed from the 1st line (the 1st scanning line A1) toward the nth line (the nth scanning line An). FIG. 7 typically illustrates this way of operating, which is an example that realizes a luminescence driving operation that is the same as that performed with respect to the weighted time gradation pattern illustrated in FIG. 6. The (A) to (C) in FIG. 7 illustrate examples of the timings, regarding each of the 1st scanning line A1 to the 3rd scanning line A3, at which a write signal and an erasure signal occur. As illustrated in FIG. 7, a write signal is sequentially supplied from the 1st scanning line toward the nth scanning line, thereby an addressing period of time occurs. The start of the addressing time period is delayed for each prescribed time period at a time from the 1st scanning line toward the nth scanning line.

Here, in the 1st sub-field (the 1st SF) period illustrated in FIG. 7, a “Vl” voltage level is applied to each of the respective cathode lines C1 to Cn, thereby the EL element 14 constituting the pixel 10 is brought to a state of its being able to luminesce. Also, in the 2nd sub-field (the 2nd SF) period illustrated in FIG. 7, with an erasure timing at which erasure is done with the luminescent time period ratio thereof being set to be ½, the voltage level is switched from “Vl” to “Vh”. The switching timing to the erasure operation at the time is delayed for each prescribed time period at a time toward the succeeding cathode lines C1 to Cn.

The above-described switching operation, in the example illustrated in FIG. 7, is also executed in each of the 3rd sub-field (the 3rd SF) period and 4th sub-field (the 4th SF) period. In addition, in the same way as described above, the switching timing is delayed for each prescribed time period at a time toward the succeeding cathode lines C1 to Cn. Like that, in the display panel 20, an image signal the weighted time gradation control of that has been performed is reproduced.

In the above-described first embodiment, a simultaneous erasing scan (SES=Simultaneous-Erasing-Scan) method has been adopted as the time division gradation expression means. In this method, for performing gradation expression, there is selectively determined one of two modes, one of which is a light-up mode in which to apply a forward-directional voltage (Va-Vl) to the EL element constituting the pixel and the other of which is a reverse bias voltage applying mode (erasing operation) in which to apply a reverse bias voltage (Va-Vh) to the EL element. And, in the reverse bias voltage applying mode, since there is provided the reverse bias voltage applying means for applying a reverse bias voltage to the EL element by bypassing the light-up drive transistor, i.e. the diode 15 that becomes electrically conductive due to the application of a reverse bias voltage, a reverse bias can be effectively applied to the EL element.

In this case, it is arranged that the cathode line for commonly connecting the cathode sides of the EL elements arrayed correspondingly to the scanning line be arrayed in the way of its being electrically separated every scanning line. And, in addition, the technique of time gradation control such as that described before is concurrently used. By doing so, it is possible to apply a reverse bias voltage to the EL element simultaneously with the erasing operation according to the time gradation control. As a result of this, it is possible to apply a reverse bias voltage to the EL element without sacrificing the luminescent duty ratio, i.e. light-up time period percentage of the EL element. Furthermore, according to the above-described first embodiment, since the erasing operation is executed with the line-sequential method, it is possible to disperse the peak current that instantaneously occurs due to applying a reverse bias voltage to the EL element and the capacitor that performs the voltage holding function.

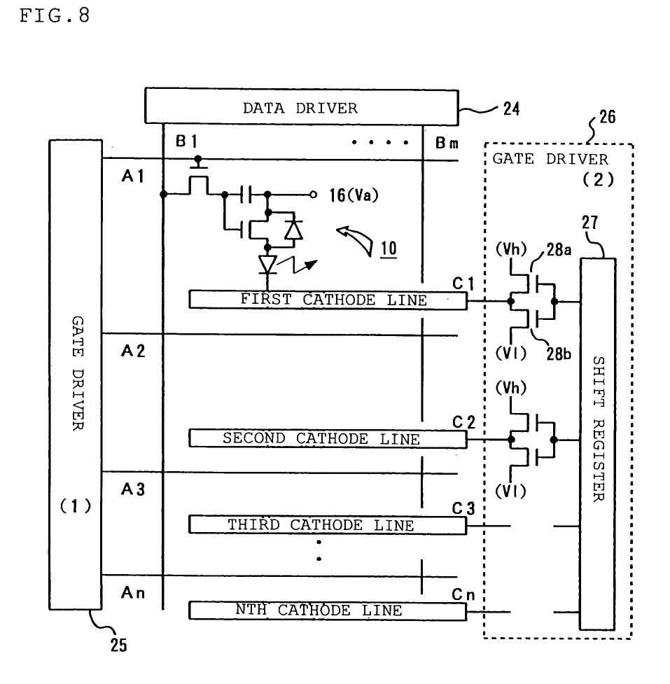

Although in the first embodiment that has been explained above an explanation has been given of an example wherein weighted time gradation control is concurrently used, the luminescent display panel driving device according to the present invention can also be applied to a drive device wherein, for example, an analog control technique is adopted as the method of gradation control. FIG. 8 refers to a second embodiment wherein the example is exemplified. This second embodiment illustrates the same construction as that which is illustrated in FIG. 5 and which has already been explained. In the second embodiment illustrated in FIG. 8, it is arranged that the respective scanning lines A1 to An have addressing performed with respect thereto by the first gate driver 25. Namely, this first gate driver 25 operates to perform the same function as that of the writing gate driver 25 illustrated in FIG. 5.

And, in the embodiment illustrated in FIG. 8, it is arranged that, when sequentially performing addressing with respect to each scanning line A1 to An, an analog output signal that corresponds to the luminance of each EL element be supplied from the data driver 24 to the respective data lines B1 to Bm. By this, to the capacitor constituting each pixel 10 there is electrically charged a voltage corresponding to the luminance of the EL element. And, according to the electric charge, the luminance of the EL element is controlled. Also, it is arranged that, in synchronism with addressing that is sequentially performed with respect to a respective one of the scanning lines A1 to An, in the second gate driver 26, it selectively supplies a reverse bias voltage with respect to each of the respective cathode lines C1 to Cn.

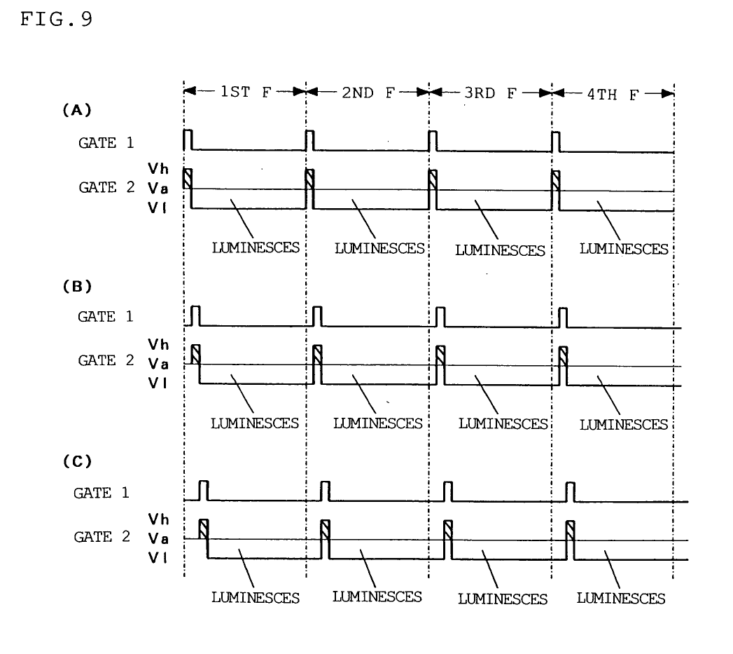

FIG. 9 illustrates an example of the control form that supplies a reverse bias voltage in the embodiment illustrated in FIG. 8. In this example, there is illustrated a case where the addressing operation is performed every separate one of the first to the fourth unit frame (the 1st F to the 4th F). And, the (A) to (C) in FIG. 9, regarding, for example, the first scanning line A1 to the third scanning line A3, illustrate the relationship between the occurrence timing of a write signal (this is expressed in FIG. 9 as the “gate 1”) due to the scan performed by the first gate driver 25 and the supply timing of a reverse bias voltage due to the scan performed by the second gate driver 26 synchronized with the occurrence timing (this is expressed in FIG. 9 as the “gate 2”). Namely, as illustrated in FIG. 9, with the line-sequential display method, a write signal is sequentially supplied from the first scanning line toward the nth scanning line, thereby an addressing period of time occurs. The start of the addressing time period is delayed for each prescribed time period at a time from the first scanning line toward the nth scanning line.

Also, in this embodiment, in the second gate driver 26, it is controlled so that the voltage “Vh” may be output in synchronism with the timing of addressing as a result of the scan performed by the first gate driver 25. Accordingly, in the embodiment illustrated in FIG. 8, correspondingly to the addressing time period, a reverse bias voltage is always applied to the EL element. Incidentally, in the embodiment illustrated in FIG. 8, it is possible to select a control form wherein, by changing the data supplied to the shift register 27 in the second gate driver 26, at the timing of addressing within one frame period, a reverse bias voltage is applied, for example, only once, to the EL element via the respective cathode lines C1 to Cn. Or, optionally, it is also possible to select a control form wherein, at the arbitrary timing of addressing, a reverse bias voltage is applied to the EL element. Accordingly, in case where having adopted the above-described means, it is possible to adjust the frequency of applying a reverse bias voltage with respect to the EL element, and this can contribute to decreasing the loss following electrical charge discharge that results from applying a reverse bias voltage.

In the second embodiment, as well, that has been explained above, it is possible to apply a reverse bias voltage to the EL element without sacrificing the light-up time period percentage. And, in case where a reverse bias voltage is applied to the EL element, since there is provided a diode that becomes electrically conductive due to the reverse bias voltage, it is possible to effectively apply a reverse bias voltage to the EL element. Furthermore, since a reverse bias voltage is applied by the line-sequential display method via the respective cathode lines C1 to Cn provided correspondingly to the scanning line, it is possible to disperse the peak current that instantaneously occurs due to applying a reverse bias voltage to the EL element and the capacitor that performs the voltage holding function.

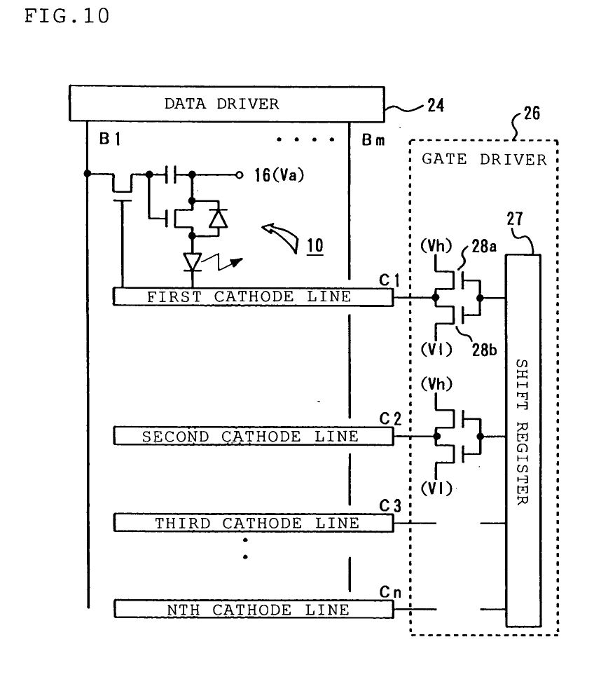

Next, FIG. 10 illustrates a third embodiment, in which there is illustrated an example having omitted therefrom the first gate driver 25 illustrated in FIG. 8. In this third embodiment, by its having omitted therefrom the first gate driver, the gates of the control TFT are respectively connected to the respective cathode lines C1 to Cn. According to this construction, by supplying a voltage “Vh” to the respective cathode lines C1 to Cn, the control TFT can be turned on, with the result that, simultaneously with the addressing operation, the operation of applying a reverse bias voltage can be achieved. Accordingly, the applying timing of a reverse bias voltage in this third embodiment illustrated in FIG. 10 is controlled according to the control form illustrated in FIG. 9 and already explained in connection therewith.

In the third embodiment, as well, that is illustrated in FIG. 10, it is possible to apply a reverse bias voltage to the EL element without sacrificing the light-up time period percentage, as in the cases of the above-described respective embodiments. At this time, it is possible to effectively apply a reverse bias voltage to the EL element 14 via the diode 15. Further, since it is arranged that a reverse bias voltage be applied by the line-sequential display method via the respective cathode lines C1 to Cn provided correspondingly to the scanning line, it is possible to disperse the peak current that instantaneously occurs due to applying a reverse bias voltage.

Incidentally, in the respective embodiments that have been explained above, it is equipped with the cathode lines C1 to Cn each having commonly connected thereto the cathode side of each luminescent element arrayed correspondingly to the scanning line, and, it is arranged that, by a potential difference between the voltage supplied to each cathode line and the common anode 16, a forward-directional voltage or reverse bias voltage be applied to each EL element. In contrast to this, it is also arranged that an anode line having commonly connected thereto the anode side of each luminescent element arrayed with respect to the scanning line be formed; and a forward-direction voltage or reverse bias voltage be applied to each EL element in the same way as stated above.

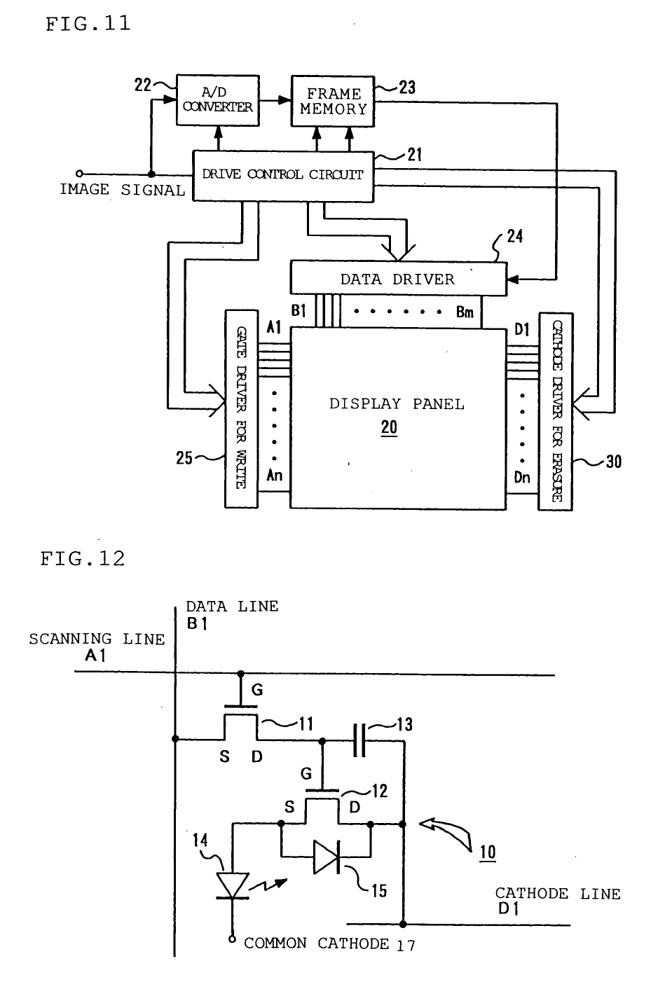

FIGS. 11 and 12 illustrate the example, and, in these figures, the portions corresponding to those illustrated in FIGS. 3 and 4 are denoted by the same reference numerals. In each pixel 10 in this fourth embodiment, as illustrated in FIG. 12, the cathode electrode of the EL element 14 is connected to the common cathode 17, while, on the other hand, the anode electrode of the EL element 14 is connected to the electrode line (in this embodiment it is called “the anode lines D1 to Dn”) arrayed in the way of its being electrically separated ever scanning line, via the drain D and source S of the drive TFT 12.

As illustrated in FIGS. 11 and 12, the anode line D1 to Dn has commonly connected thereto the anode side of each luminescent element arrayed correspondingly to a relevant one of the scanning lines A1 to An, and, it is arranged that a respective one of the anode lines D1 to Dn has its potential level controlled by the erasing anode driver 30. This erasing anode driver 30, as an example, is constructed, similarly to the erasing cathode driver 26 illustrated in FIG. 5, in the way of its being equipped with the shift register 27, and the TFTs 28a and 28b for use in switching.

And, in case where having set the potential level of the common cathode 17 illustrated in FIG. 12 to be, for example, a reference potential (the earth potential=0 V), applying a positive potential of +10 V or so via the switching FET enables supplying a forward-directional voltage able to cause luminescence to the EL element 14. Also, in case where having applied a negative potential of −8 V or so to the anode line D1 via the switching FET, a reverse bias voltage can be applied to the EL element 14.

As seen from the foregoing description, in the fourth embodiment, as well, illustrated in FIGS. 11 and 12, a reverse bias voltage can be applied via the respective anode lines D1 to Dn and, in this case as well, in the same way as was stated in the preceding embodiments, a reverse bias voltage can be effectively applied to the EL element 14 via the diode 15. In addition, since a reverse bias voltage is applied according to the line-sequential method via the respective anode lines D1 to Dn corresponding to the scanning line, it is possible to disperse the peak current that instantaneously occurs due to applying a reverse bias voltage.

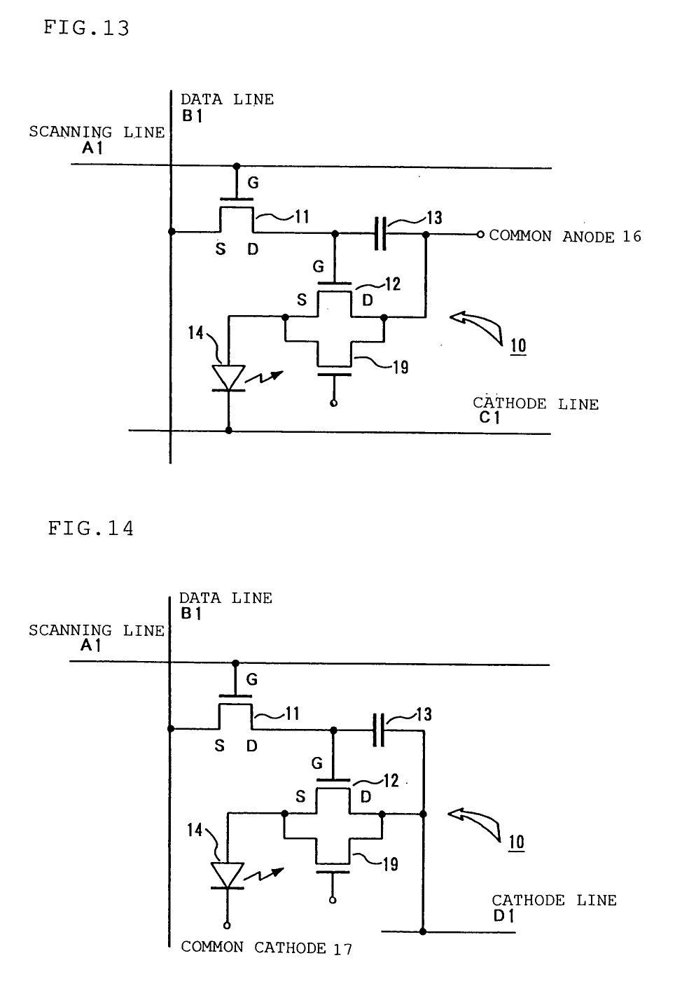

In the respective embodiments that have been explained above, an example is illustrated wherein the diode is connected in parallel to the light-up drive transistor 12 and is thereby brought to an electrically conductive state due to the application of a reverse bias voltage. Other than this, it may be also arranged that a switching TFT, in place of the diode 15, be inserted between the drain and source of the light-up drive transistor 12. FIG. 13 illustrates the example. There, in place of the diode 15, the TFT 19 is connected in the circuit construction corresponding to one pixel 10 illustrated in FIG. 4. And, the circuit is controlled in the way a signal that turns on the TFT 19 is supplied, during a reverse bias applying period, to the gate of the TFT 19.

FIG. 14 also illustrates another example that, in place of the diode 15, utilizes the TFT 19. This example is the one that has been applied to the circuit construction corresponding to one pixel 10 illustrated in FIG. 12, which was already explained in connection therewith. And, the circuit is controlled in the way in which, to the gate of the TFT 19, similarly, there is supplied, during a reverse bias applying period, a signal that causes the TFT 19 to perform its “on”-operation.

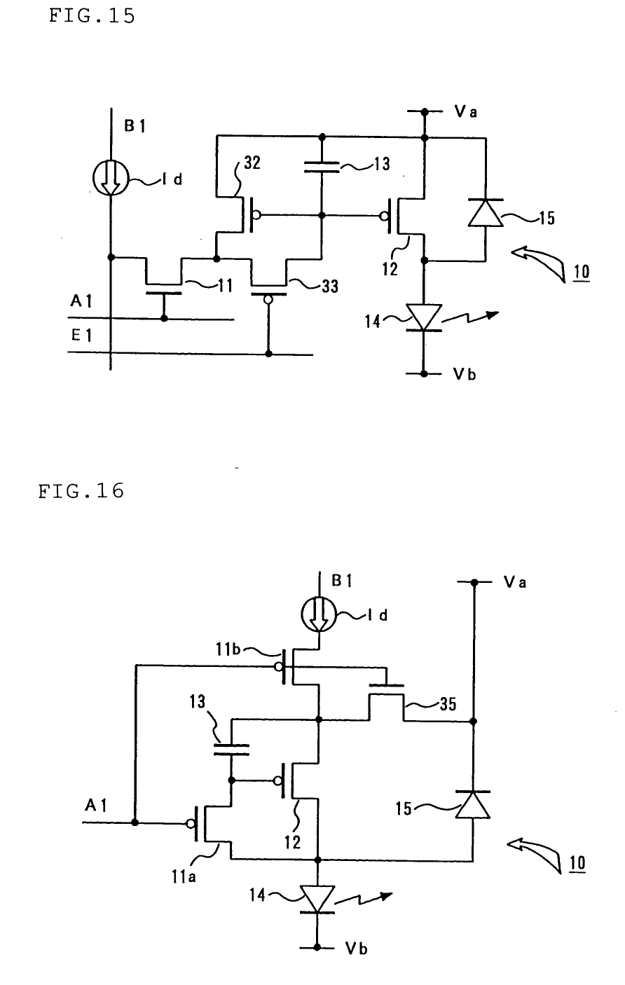

In the respective embodiments that have been explained above, in any one thereof, an example is illustrated which is constructed in the way one pixel is constructed of a combination (2 transistors) of the control TFT 11 and the drive TFT 12. However, the circuit construction that will be explained the next is the one that stands fundamentally on the above-described 2-transistor construction and that is additionally equipped with still another control transistor. Namely, the example illustrated in FIG. 15 is the one that adopts means that electrically discharges the charge held in the capacitor 13 by the erasing TFT with a prescribed timing. In other words, the example of FIG. 15 is a fifth embodiment wherein the invention has been applied to a circuit example that uses the erasing TFT.

In this FIG. 15, there is illustrated a circuit construction corresponding to one pixel 10 in the display panel. As illustrated in FIG. 15, between the voltage lines Va and Vb, there are connected in series the drive TFT 12 and the EL element 14. And, to the drive TFT 12 there is connected in parallel a diode 15, which becomes electrically conductive when applied with a reverse bias voltage. A terminal voltage of the charge holding capacitor 13 allows to be applied to its gate so that the drive TFT 12 causes a constant current to flow into the EL element 14 to thereby enable bringing the EL element 14 to a state of luminescence.

On the other hand, the gate of the control TFT11 is connected to the scanning line (the scanning line A1) and the source thereof is connected to the data line (the data line B1) having thereon a writing current source Id. With this construction, the control TFT 11 operates, within the addressing time period, to cause an electric charge corresponding to the current value from the power source Id to be accumulated into the capacitor 13 via the TFT 32. Incidentally, the TFT 32, jointly with the drive TFT 12, constitutes a so-called “current mirror circuit”. Also, in this circuit construction, there is equipped an erasing TFT 33, which is constructed in the way its gate is applied with a control voltage via an erasing line E1.

In the circuit construction of FIG. 15, within the addressing time period, it is arranged that the writing operation be performed with respect to the capacitor 13 via the TFT 11 and TFT 32. According thereto, the drive TFT 12 causes a flowing to the EL element 14 of an electric current corresponding to the terminal voltage of the capacitor 13, with the result that, during the unit frame period, the EL element 14 can go on luminescing. In this case, it is arranged that an erasing signal be supplied to the erasing line E1 at a prescribed timing within the unit frame period. As a result of this, the electric charge accumulated in the capacitor 13 is discharged via each of the TFTs 32 and 33 and, therefore, the luminescence of the EL element 14 is stopped at the timing.

In the circuit construction, as well, illustrated in FIG. 15, it can be arranged that the voltage line Va be made a fixed voltage; and, as illustrated in, for example, FIG. 5, the voltage line Vb be obtained through the cathode lines C1 to Cn formed correspondingly to the scanning line A1 to An. In a case where having constructed like that, by setting the voltage level supplied to the cathodes line C1 to Cn to be “Vh” or “Vl”, a reverse bias voltage or forward-directional voltage can be applied to the EL element 14 as in the case of the operation explained in connection with FIG. 5.

Also, by changing the voltage level of the voltage line Va illustrated in FIG. 15, similarly, a reverse bias voltage or a forward-directional voltage can be applied to the EL element 14. In this case, due to the change in voltage level of the voltage line Va, the phenomenon of the electric current being “turned round” occurs with respect to the current source Id. To avoid this, it is preferable to control so that the TFT 11 or TFT 32 constituting the current path may be turned off.

In this fifth embodiment, as well, that refers to the circuit construction illustrated in FIG. 15, a reverse bias voltage can be applied to the EL element 14 via the diode 15. Also, since it is arranged that a reverse bias voltage be applied, using the line-sequential method, via the respective cathode lines C1 to Cn provided correspondingly to the scanning line, it is possible to disperse the peak current that instantaneously occurs due to applying a reverse bias voltage.

FIG. 16 the view of that is shown the next illustrates a sixth embodiment that is equipped, in addition to the basic construction of one pixel constructed, similarly, of two transistors, with another control transistor. The circuit construction illustrated in FIG. 16 is called “the current write-in circuit”. Namely, between the voltage lines Va and Vb, the switching TFT 35, drive TFT 12, and EL element 14 are connected in series to one another.

And a diode 15 that is connected in parallel to a serial circuit consisting of the switching TFT 35 and drive TFT 12 and that, when applied with a reverse bias voltage, becomes electrically conductive is disposed. The drive TFT 12 can cause a flowing of a constant current to the EL element 14 according to the terminal voltage (gate voltage) of the charge holding capacitor 13, thereby the EL element 14 can be brought to a state of luminescence.

On the other hand, the gates of the control first TFT 11a and second TFT 11b are each connected to the scanning line (the scanning line A1). And it is arranged that the current from the data line (the data line B1) having thereon a writing current source Id be electrically charged via the second TFT 11b. By this constructing, during the addressing time period, by the control voltage on the scanning line A1, the switching TFT 35 is turned off and, on the other hand, the control first TFT 11a and second TFT 11b are turned on. Accordingly, in the capacitor 13 there is accumulated an electric charge corresponding to the electric current from the writing current source Id.

Simultaneously with the termination of the addressing time period, both the control first TFT 11a and the control TFT 11b are turned off and the switching TFT 35 is turned on. As a result of this, the switching TFT 35, drive TFT 12, and EL element 14 are connected in series between the voltage line Va and the voltage line Vb. And, the drive TFT 12 operates to cause the EL element 14 to luminesce correspondingly to the amount of electric charge (i.e. the write-in current value supplied from the above-described Id) accumulated in the capacitor 13.

In the circuit construction, as well, illustrated in FIG. 16, it can be arranged that the voltage line Va be made a fixed voltage; and, as illustrated in, for example, FIG. 5, the voltage line Vb be obtained from the cathode lines C1 to Cn formed correspondingly to the scanning line A1 to An. In a case where having constructed like that, by setting the voltage level supplied to the cathode lines C1 to Cn to be “Vh” or “Vl”, a reverse bias voltage or a forward-directional voltage can be applied, as in the case of the operation explained in connection with FIG. 5, to the EL element 14.

Also, by changing the voltage level of the voltage line Va in FIG. 16, similarly, it is possible to apply a reverse bias voltage or a forward-directional voltage to the EL element 14. In this case, if either the TFT 11b or the TFT 35 is in an “off” state, it is possible to avoid causing interference to the writing current source Id by the change in voltage level of the voltage line Va.

In the sixth embodiment, as well, having the circuit construction illustrated in FIG. 16, a reverse bias voltage can effectively be applied to the EL element 14 via the diode 15. In addition, since a reverse bias voltage can be applied using the line-sequential method via the respective cathode lines C1 to Cn corresponding to the scanning line, it is possible to disperse the peak current that instantaneously occurs due to applying a reverse bias voltage.

Incidentally, in the circuit construction, as well, that is illustrated in each of FIGS. 15 and 16, as was explained in connection with FIGS. 13 and 14, a switching TFT 19 may be used instead of the diode 15. In a case where having used the switching TFT, the circuit is controlled in the way that, within the reverse bias voltage applying period, a signal causing the TFT to be turned on is supplied.

What is claimed is:

1. A device for driving a luminescent display panel, the device being the one for driving an active matrix type display panel that is equipped with a plurality of luminescent elements that are arrayed at the positions of intersection between a plurality of data lines and a plurality of scanning lines and at least each one of that is luminescence controlled via a light-up drive transistor,
having a construction wherein a light-up mode in which a forward-directional voltage is applied to the luminescent element via the light-up drive transistor and a reverse bias voltage applying mode in which a reverse bias voltage is applied to the luminescent element via the light-up drive transistor can be selectively determined, and
wherein, in case where the reverse bias voltage applying mode is selected, there operates reverse bias voltage applying means that applies a reverse bias voltage to the luminescent element while bypassing the light-up drive transistor.

2. The device for driving a luminescent display panel, according to claim 1, wherein the reverse bias voltage applying means includes a diode or TFT that, by being connected in parallel to the light-up drive transistor, becomes electrically conductive when applied with a reverse bias voltage.

3. The device for driving a luminescent display panel, according to claim 1 or 2, wherein electrode lines having commonly connected thereto the plurality of luminescent elements arrayed correspondingly to the scanning lines are formed in the way of their being electrically separated every scanning line, whereby the device has a construction wherein, by applying a prescribed voltage level to the respective electrode lines, the reverse bias voltage applying mode is selected.

4. The device for driving a luminescent display panel, according to claim 3, wherein the electrode lines are cathode lines having commonly connected thereto the cathode sides of the respective luminescent elements arrayed correspondingly to the scanning lines.

5. The device for driving a luminescent display panel, according to claim 3, wherein the electrode lines are anode lines having commonly connected thereto the anode sides of the respective luminescent elements arrayed correspondingly to the scanning lines.

6. The device for driving a luminescent display panel, according to claim 1 or 2, wherein the luminescent element is constructed with the use of an organic EL element that uses an organic compound as the material of the luminescent layer.

7. The device for driving a luminescent display panel, according to claim 3, wherein the luminescent element is constructed with the use of an organic EL element that uses an organic compound as the material of the luminescent layer.

8. The device for driving a luminescent display panel, according to claim 4 or 5, wherein the luminescent element is constructed with the use of an organic EL element that uses an organic compound as the material of the luminescent layer.

9. The method of driving an active matrix type display panel that is equipped with a plurality of luminescent elements that are arrayed at the positions of intersection between a plurality of data lines and a plurality of scanning lines and at least each one of that is luminescence controlled via a light-up drive transistor,
comprising a luminescent element light-up step of applying a forward-directional voltage to the luminescent element via the light-up drive transistor and a reverse bias voltage applying step of applying a reverse bias voltage to the luminescent element via the light-up drive transistor,
whereby, in case where the reverse bias voltage applying step is executed, there operates reverse bias voltage applying means that applies a reverse bias voltage to the luminescent element while bypassing the light-up drive transistor.

10. The method of driving a luminescent display panel, according to claim 9, wherein electrode lines having commonly connected thereto the plurality of luminescent elements arrayed correspondingly to the scanning lines are formed in the way of their being electrically separated every scanning line, whereby a reverse bias voltage is applied in the way in which the timings of applying it do not coincide with each other every electrode line.

11. The method of driving a luminescent display panel, according to claim 10, wherein a unit frame period is divided into a plurality of sub-field periods; according to the luminescing time period percentage of the luminescent element that is determined every sub-field, multi-gradation expression is executed; and, within the non-luminescing time period of the luminescent element in the sub-field period, a reverse bias voltage is applied.

12. The method of driving a luminescent display panel, according to claim 10, wherein, within an addressing period of time wherein addressing is done every scanning line, a reverse bias voltage is applied to the electrode line.
